(19) United States
(12) Patent Application Publication
(10) Pub. No.: US 2026/0078241 A1
(43) Pub. Date: Mar. 19, 2026

(54) BITUMEN COMPOSITES WITH IMPREGNATED ZEOLITES

(71) Applicants: Elham Fini, Phoenix, AZ (US); Dong-Kyun Seo, Chandler, AZ (US); Sand Aldagari, Tempe, AZ (US); Masoumeh Mousavi, Tempe, AZ (US)

(72) Inventors: Elham Fini, Phoenix, AZ (US); Dong-Kyun Seo, Chandler, AZ (US); Sand Aldagari, Tempe, AZ (US); Masoumeh Mousavi, Tempe, AZ (US)

(21) Appl. No.: 19/398,900

(22) Filed: Nov. 24, 2025

Related U.S. Application Data
(63) Continuation of application No. 18/450,535, filed on Aug. 16, 2023.
(60) Provisional application No. 63/371,603, filed on Aug. 16, 2022.

(51) Int. Cl. C08K 9/12; C01B 39/02; C08J 3/20; C08K 3/36; C08L 95/00

(52) U.S. Cl. CPC C08K 9/12; C01B 39/026; C08J 3/203; C08K 3/36; C08L 95/00; C08J 2395/00; C08L 2555/60

(57) ABSTRACT

A bitumen composite includes an amine-impregnated zeolite and bitumen. Forming the bitumen composite includes combining bitumen and an amine-impregnated zeolite to yield a mixture, heating the mixture to yield the bitumen composite.

### CROSS-REFERENCE TO RELATED APPLICATIONS

This application is a continuation of U.S. patent application Ser. No. 18/450,535 filed on Aug. 16, 2023, which claims the benefit of U.S. patent application Ser. No. 63/371,603 filed on Aug. 16, 2022, both of which are incorporated by reference herein in their entirety.

### STATEMENT OF GOVERNMENT SUPPORT

This invention was made with government support under 1928795 awarded by the National Science Foundation. The government has certain rights in the invention.

### TECHNICAL FIELD

This invention generally relates to bitumen composites with amine-impregnated zeolites for use as antistripping agents in asphalt.

### BACKGROUND

Antistripping agents are among the chemical additives used in warm-mix asphalt (WMA) to improve the durability of the asphalt by reducing its susceptibility to moisture. Moisture disrupts the adhesion between the binder (bitumen) and aggregates (e.g., sand, crushed stone, gravel, rock dust), reducing the useful lifetime of the asphalt.

### SUMMARY

This disclosure describes an amine-impregnated zeolite that functions as a solid amine-based antistripping agent to enhance the durability of bitumen composites, including asphalt. Antistripping agents are combined with bitumen to reduce the susceptibility of asphalt to moisture, which disrupts the adhesion between the bitumen and aggregates. Amine-based liquid antistripping agents can lose their efficacy over time (e.g., when exposed to high temperatures). For amine-impregnated zeolite solid antistripping agents, the amine molecules loaded into the zeolite's pores can be gradually released into the matrix of bitumen and act as antistripping agents over a longer length of time, leading to increased durability of the asphalt. A solid antistripping agent using zeolite as a carrier can be made using liquid antistripping agents.

In a first general aspect, a bitumen composite includes an amine-impregnated zeolite and bitumen. The amine-impregnated zeolite includes a zeolite impregnated with an amine.

Implementations of the first general aspect may include one or more of the following features.

In some implementations, the bitumen composite includes about 0.1 wt % to about 5 wt % of the amine. A weight ratio of the amine to the zeolite is up to about 1 (e.g., about 0.6 to 1). The bitumen composite typically includes up to 5 wt % of the zeolite. One example of a suitable amine is ethylenediamine. The zeolite can be a natural or synthetic zeolite. In some cases, the zeolite is a Faujasite-type zeolite.

In implementations, the bitumen composite further includes an aggregate. The aggregate can include one or more of sand, crushed stone, gravel, and rock dust.

In a second general aspect, forming a bitumen composite includes combining bitumen and an amine-impregnated zeolite to yield a mixture, and heating the mixture to yield the bitumen composite. The amine-impregnated zeolite includes a zeolite impregnated with an amine.

Implementations of the second general aspect may include one or more of the following features.

Some implementations include heating the mixture to a temperature of about 100° C. to about 200° C. Heating the mixture can include heating the mixture for about 1 minute to about 100 minutes.

In some implementations, the bitumen composite includes about 0.1 wt % to about 5 wt % of the amine. A weight ratio of the amine to the zeolite is up to about 1 (e.g., about 0.6 to 1). The bitumen composite typically includes up to 5 wt % of the zeolite. One example of a suitable amine is ethylenediamine. The zeolite can be a natural or synthetic zeolite. In some cases, the zeolite is a Faujasite-type zeolite.

Some implementations include combining the bitumen composite with an aggregate. The aggregate can include one or more of sand, crushed stone, gravel, and rock dust.

In a third general aspect, a composition includes the bitumen composite of the first general aspect.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1A depicts two cluster models isolated from the {111} Faujasite surface: a supercage-window cluster and a small cage (sodalite). FIG. 1B is a schematic representation of a sodalite cage cut out with three Miller index surfaces, {111}, {100}, and {011}.

FIGS. 2A and 2B are plots of viscosity versus shear rate and slope of shear thinning (Power-Law Slope), respectively, for bitumen with amine-impregnated zeolite, before and after water conditioning.

FIG. 3 is a plot showing the moisture-induced shear-thinning index (MISTI) deviation from 1 for bitumen with non-treated zeolite, bitumen with amine-impregnated zeolite, and bitumen with amine and zeolite.

FIG. 4 is a plot showing the linear interpolation used to estimate the amine released into bitumen from amine-impregnated zeolite, based on bitumens containing zeolite.

FIG. 5 is a plot showing the percent change in resistance to moisture damage in bitumen with amine-impregnated zeolite, and bitumen containing amine and zeolite added separately.

FIGS. 6A and 6B depict the adsorption of ethylenediamine onto the {111} sodalite cage and {100} sodalite cage, respectively. FIG. 6C depicts ethylenediamine inside a 12-member entrance window of a Faujasite supercage. The small, light-purple balls in the center of the 12-member ring represent Na cations. FIG. 6D depicts the interaction between an ethylenediamine molecule and a Na cation, isolated from the zeolite medium.

FIGS. 7A-7C are plots comparing the adsorption of ethylenediamine with seven small polar molecules of bitumen, in terms of energy (kcal/mol) on three adsorption sites of a Faujasite zeolite model: {100} sodalite cage (broken cage); {111} sodalite cage (top of the 6-ring window of the sodalite cage); and a 12-member supercage window, respectively.

FIGS. 8A and 8B depict the breaking bonds and forming of new bonds in small organic compounds of bitumen in zeolite pores: ring-opening C—S bond cleavage of thiophene; and S—H bond cleavage and intermolecular H-transfer in hexanethiol on top of the 6-ring window of a sodalite cage, respectively.

### DETAILED DESCRIPTION

This disclosure describes an amine-impregnated zeolite that functions as a solid amine-based antistripping agent to enhance the durability of bitumen composites, including asphalt. Antistripping agents are combined with bitumen to reduce the susceptibility of asphalt to moisture, which disrupts the adhesion between the bitumen and aggregates. Amine-based liquid antistripping agents lose their efficacy over time, particularly when exposed to high temperatures. For amine-impregnated zeolite solid antistripping agents, the amine molecules loaded into the zeolite's pores can be gradually released into the matrix of bitumen and act as antistripping agents over a longer length of time, leading to increased durability for the asphalt. A solid antistripping agent using zeolite as a carrier can be made using liquid antistripping agents.

A bitumen composite with an amine-impregnated zeolite includes about 0.1 wt % to about 5 wt % of the amine. One example of a suitable amine is ethylenediamine. The weight ratio of the amine to the zeolite is typically up to about 1. The weight ratio of the amine to the zeolite is typically in a range of about 0.6 to 1. The bitumen composite typically includes up to 5 wt % of the zeolite. Suitable zeolites include natural and synthetic zeolites. Examples of suitable zeolites include Faujasite-type zeolites. The bitumen composite with the amine impregnated zeolite can further include one or more aggregates (e.g., sand, crushed stone, gravel, and rock dust).

A method of forming the bitumen composite with an amine-impregnated zeolite includes combining bitumen with an amine-impregnated zeolite and heating the mixture to a temperature of about 100° C. to about 200° C. for about 1 minute to about 100 minutes.

Zeolite cavities can protect amine-based antistripping additives that would otherwise be susceptible to aging. In addition to abundant naturally occurring zeolite, synthetic zeolites can be a low-cost alternative made from sewage sludge ash, turning waste into a value-added product while removing toxic contaminants found in sewage.

Moisture-induced shear-thinning index (MISTI) tests can be performed to evaluate the moisture resistance of bitumen samples including anti-stripping additives of pure ethylenediamine, pure zeolite, amine-zeolite (non-treated), and amine-impregnated zeolite. A rolling thin-film oven (RTFO) and a pressure aging vessel (PAV) can be used to simulate the short-term aging and long-term field oxidative aging of bitumen samples, respectively. To gain molecular-level insight into the adsorption behaviors of amine-impregnated zeolite and the replacement of amine molecules with some small molecules of bitumen, a series of quantum-based calculations can be performed using a dispersion-corrected density functional theory (DFT-D) approach.

### EXAMPLES

### Sample Preparation

A bitumen known to be susceptible to moisture was selected. Modification of bitumen was carried out by addition of modifiers into the bitumen; mixing was performed at a temperature of 150° C. for 10 min. To prepare a bitumen composite including an amine-impregnated zeolite, the amine was added to zeolite at a ratio of (0.62:1) and mixed well, so that all amine was absorbed by the zeolite powder. The amount of powder added to the bitumen was calculated to ensure that 1 wt % amine (based on the weight of the bitumen) was introduced into the bitumen. For example, to prepare 20 g of bitumen composite, 0.20 g of amine (1 wt % amine) was added to 0.32 g zeolite (0.62:1 amine to zeolite); this amine-impregnated zeolite was added to the bitumen. For bitumen with non-treated zeolite, the same amount of zeolite used in preparing the bitumen with amine-impregnated zeolite was incorporated into bitumen as non-treated powder. This amount of zeolite corresponds to 1.6 wt % (based on the weight of the bitumen). For bitumen with amine and zeolite, the same amounts of zeolite and amine used in preparing the bitumen with amine-impregnated zeolite were added separately into bitumen. In this case, the amine was free and not absorbed by the zeolite powder. Therefore, three types of bitumen containing zeolite were prepared and tested.

### Moisture-Induced Shear-Thinning Index

The moisture-induced shear-thinning index (MISTI) was developed to quantify the susceptibility of a bitumen-aggregate interface to moisture damage. To determine the MISTI, a shear-rate ramp test was performed on a mixture of stones and bitumen, using a dynamic shear rheometer (Anton Paar MCR 302 DSR) with an 8-mm spindle. A mixture containing a 2:1 ratio of bitumen and glass beads was placed in silicon molds to form 8-mm disk-shaped specimens. Each specimen was then demolded and placed in a parallel-plate test setup of the DSR to be tested. A ramping shear rate (0.1 to 100 1/s) was applied on the specimen, and the viscosity value was measured at each shear rate. The testing temperature was adjusted so that the initial viscosity was close to 1000 Pa s. A plot of viscosity versus shear rate was then used for analysis. Three types of bitumens were tested: bitumen with non-treated zeolite, bitumen with amine-impregnated zeolite, and bitumen with amine and zeolite. For each bitumen, two samples were tested while remaining unconditioned, and the other two samples were conditioned in distilled water at 60° C. for 24 hours before testing. After that, the MISTI value was determined for each bitumen using Eq. 1, based on the shear-thinning slopes before and after water conditioning. The change in shear-thinning slope after water conditioning is related to the effect of water at the interface between bitumen and glass beads. A MISTI value closer to 1 indicates better resistance to moisture damage.

$$MISTI = \frac{Average shear - thinning slope of unconditioned samples}{Average shear - thinning slope of water - conditioned samples} \qquad ( 1 )$$

The moisture-induced shear-thinning index is a test that specifically characterizes the susceptibility of a bitumen-stone interface to moisture damage. MISTI is based on the science of surface energy, adsorption, and desorption dynamics at the interface. Since the role of an amine-based antistripping agent is to modify the interface between bitumen and stone aggregates, the MISTI test is best suited to evaluate any changes at the interface.

### Laboratory Aging

The aging test used a rolling thin-film oven (RTFO) for short-term aging and a pressure aging vessel (PAV) for long-term aging of two mixtures separately: the mixture containing amine-impregnated zeolite bitumen and glass beads; and the mixture containing amine and zeolite bitumen and glass beads. Short-term aging was performed by applying a temperature of 163° C. and an airflow rate of 4 L/minute for 85 min, following the standard AASHTO T240. Then, long-term aging was conducted by applying an air pressure of 2.10 MPa and a temperature of 105° C. on bitumens aged from the RTFO, following the standard AASHTO PP1. The durations of aging in the PAV were set to be 20 h, 40 h, or 60 h, referred to as 1PAV, 2PAV, and 3PAV, respectively.

### Computational Details

Zeolites are porous materials with a 3-D network of (SiO₄)⁴⁺ and (AlO₄)⁵⁺ tetrahedron units linked to one another to form open cavities in the form of cages and channels. A zeolite structure is usually described by the type of zeolite's framework in terms of the size of the pore openings and the dimensionality of the channel system. Pore openings (entrance windows) are characterized by the size of the ring defining the pore: an 8-member ring is considered as a small pore opening, a 10-member ring a medium one, and a 12-member ring a large one, with free diameters of approximately 4.1, 5.5, and 7.4 Å, respectively. With pore openings of 7.4 Å, the Faujasite-type zeolites are among the largest-pore zeolites currently used in industry. In Faujasite-type zeolites, 12-member-oxygen rings of pore openings, with a free diameter of 7.4 Å, lead to access the small cages, named sodalite cages (β-cages, with 6.3 Å diameter), and large cages (supercages, with about 12 Å diameter). In a complete (intact) structure, sodalites are not accessible, even for small molecules, due to their narrow 6-member ring openings of about 2.5 Å, implying that these materials are not used in their full capacity.

Natural zeolites have limited applications in industry due to their crystal structure and small pores; however, more than 200 types of zeolites with different crystal structures have been obtained synthetically. The particles of synthetic zeolites can be formed into a desired shape that has many advantages in scale-up. Depending on the Si/Al ratio, synthetic Faujasite zeolites are commonly categorized into zeolite X (with a ratio of Si/Al=1-1.5) and zeolite Y (with a ratio of Si/Al=1.5-2). X zeolites (with a higher Al content) are unstable in water and acids at elevated temperatures; Y zeolites (with a higher Si content) provide higher thermal stability for the zeolite.

The synthetic zeolite used in this test, synthesized through a “geopolymer gel” route, is a sodium aluminosilicate product containing Faujasite, Linda type A, and Sodalite frameworks for the precursor mixture compositions of Si/Al=2 and Na/Al=3. The pure phase of Faujasite is obtained only in ratios of Si/Al=3 and Na/Al=4, which implies a narrow phase region for the structure. However, considering the large size of the pore openings in Faujasite nanozeolites and their high capacity as a carrier, a Faujasite-type zeolite was modeled for the DFT calculations.

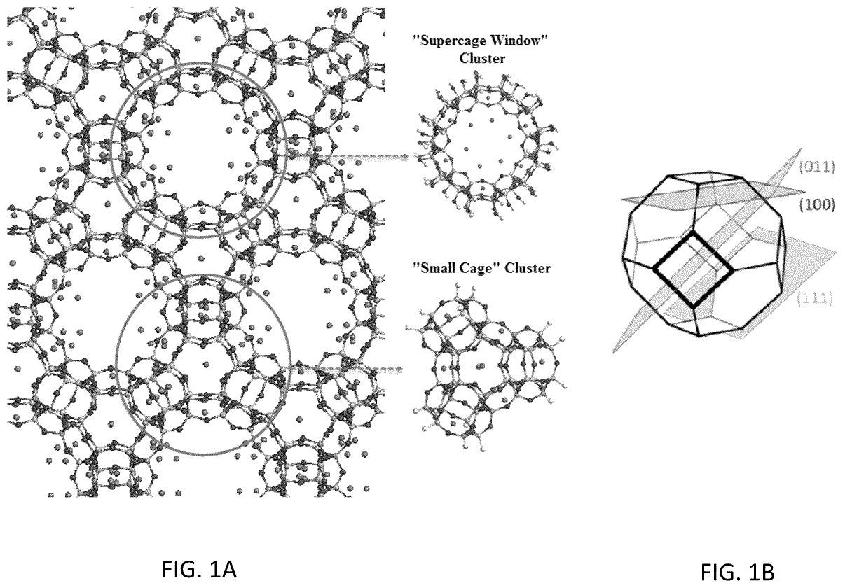

The initial geometry of the Faujasite-Na unit cell used in this test was derived from the structural and crystal-chemical features reported in AMCSD (American Mineralogist Crystal Structure Database) with the database code 0006772 information. This unit cell with the chemical formula of Na₂₅₆Al₉₆Si₉₆O₃₈₄ has cell length parameters a=b=c=25.10 Å and cell angles α=β=γ=90°. The ratio of Na:Al:Si=2.7:1:1 in this low-silica dehydrated zeolite was changed to Na:Al:Si=2.5:1:2 to simulate the chemical composition of its synthetic analogue. The newly formed cell has fewer Na cations, resulting from the decrease in Al content, leading to a reduced polarity in the supercage network compared to the zeolite with high Al content. The primitive unit cell of Faujasite-Na with the chemical formula of Na₄₀Al₁₆Si₃₂O₉₆ is shown in FIG. 1A. From the primitive unit cell, a periodic slab was created by the {111} surface model of Faujasite, with 20 Å vacuum, and fully optimized to be used in the next step: making cluster models.

The CASTEP module implemented in the Accelrys Materials Studios program package was used to create the periodic slab and to perform the DFT plane-wave pseudopotential calculations to optimize the target slab. The PBE (Perdew-Burke-Ernzerhof) exchange-correlation functional of generalized gradient approximation (GGA), and Grimme's dispersion correction were used to generate a general functional termed PBE-D. The overall quality of “Medium”, with kinetic-energy cut-off of 330 eV and k-point (1×1×1), was set for numerical calculations. Under ultrasoft pseudopotential, full atomic position optimization was performed. At this level of calculation, the convergence criteria for energy, maximum force, stress, and displacement would be 2.0×10⁻⁵ eV/atom, 5×10⁻² eV/Å, 1×10⁻¹ GPa, and 2×10⁻³ Å, respectively.

### Cluster Approach

In the cluster approach, molecular clusters are decoupled from the surrounding lattice in a periodic structure to study the interactions between target organic molecules and specific parts of the zeolite. Here, the molecular clusters were isolated from the corresponding fully optimized slab made in the periodic boundary condition (PBC) approach discussed earlier. Two clusters were decoupled from the PBC slab: 1—an entrance window (pore opening) of a supercage characterized by a 12-member-oxygen ring; and 2—a sodalite cage with its surrounding lattice containing three hexagonal prisms. Both clusters accommodate a number of monovalent extra-framework cations of Na whose positions in the model zeolite are determined using energy minimization, as implemented in DMol3 code. The terminal atoms of the 12-member ring were capped with H for O atoms and with OH for Al atoms and Si atoms. In the sodalite case, all the broken bonds in layers far from the interactions were saturated with H atoms. A supercage window and a small cage (sodalite) of the Faujasite-type zeolite, viewed along the {111} surface, are shown in FIG. 1A.

To preserve the bulk-like rigidity below the surfaces and at positions far from the interactions, some layers were kept fixed during the optimization of adsorption complexes; in the figures pertaining to the clusters and their interactions, variable atom positions are shown in “ball and stick”, and fixed atoms are shown in “line”. If this rigidity is lost due to truncation, the system behaves like a molecule with a certain degree of artificial flexibility, leading to an overestimation of the binding energy.

Optimization of the clusters and their corresponding interactions with organic compounds was performed through the non-periodic DMol3 module implemented in the Accelrys Materials Studio program package. As for the PBC approach described, PBE was used as the exchange-correlation functional, and Grimme's dispersion correction was added to the calculations to include the long-range dispersion correction. A double numeric basis set, DND, was used for all-electron optimization. At this level of calculation, the tolerances for energy, maximum force, and displacement convergence were 2.0×10⁻⁵ Hartree, 4.0×10⁻³ Hartree/Å, and 5.0×10⁻³ Å, respectively.

Adsorption energy (E_{ads}), the energy for the interaction between the zeolite clusters and organic molecules, was calculated using Eq. 2, where E_{complex} is the energy of the optimized adsorption complex, and E_{Organic Compound} and E_{Cluster} are the calculated energies for the isolated components (organic compound and zeolite cluster) when they are in their lowest energy states.

$${E}_{ads} = {E}_{complex} - ( {E}_{Organic compound} + {E}_{Cluster} ) \qquad ( 2 )$$

### Zeolite Surfaces

A zeolite's external surfaces influence the zeolite's reactivity, growth mechanism, and properties. Based on the findings of the molecular dynamics simulation, the surface structure of zeolites impact the adsorption and transport of CO₂ and the binary mixture of CO₂/N₂ in Faujasite zeolites, and in the adsorption of CH₄ gas molecules in Linde type A and AFI zeolites. Many surface configurations are possible to cut out from zeolites, however, Miller index surfaces are known as the most significant surfaces of a crystal with the highest stability. In this test, the minimized structure of a sodalite cage was cut along the Miller indices to obtain the surfaces with general orientations {100}, {011}, and {111}. A further consideration for cleaving a crystal is the formation of dangling bonds such as three-coordinate Si or one-coordinate O at the truncated surface. In many cases, created surfaces are hydroxylated to saturate the broken bonds of Al or Si. In this test, dangling bonds were terminated to H atoms to provide a neutral surface model while avoiding exaggerating the number of hydroxyl groups accessible to interact with approaching guest molecules and consequently overestimating the adsorption energy values.

FIG. 1B depicts how the sodalite cage is broken by the surface cuts {100}, {011}, and {111}. The {111} surface is identified as the most stable face and therefore is predicted to be the dominant surface in crystal morphology. The {111} surface cuts through the hexagonal prisms (double 6-rings) between the sodalite cages; that is why the sodalite cage is not broken by this cut, and inside the cage is not accessible to guest molecules. Although the sodalite cage will be intact in the {111} cut, interaction of guest molecules with an exterior wall of the sodalite cage cannot be overlooked.

In contrast to the {111} cut, the {011} and {100} surfaces cut through the sodalite cage, leaving the inside of the cage accessible to guest molecules. Referring to FIG. 1B, in {100} termination, the {100} plane is oriented parallel to one single 4-ring face, leaving the cage open to the entry of guest molecules; the cleaved bonds of the uppermost part of the cage turn the broken edges into strong adsorption sites. Compared to the {100} plane, the {011} plane cuts more spaces of the cage; the {011} plane passes through the middle of the 6-ring window and cuts the sodalite cage in half. The {011} surface leaves more active sites for interaction with guest molecules and acts as a strong adsorption site.

The interactions of ethylenediamine and seven polar molecules of bitumen with a sodalite cage were tested for two cases: cut out with the {111} surface, where the cage is intact and the interactions are limited to the exterior wall of sodalite; and cut out with the {100} surface, where the cage is broken and the active sites of the broken edge and interior space of sodalite are accessible.

### Potential Candidates for Substitution of Ethylenediamine in Zeolite Pores

To test the capability of zeolite as the adsorbate for some bitumen compounds, the adsorption behavior of ethylenediamine in zeolite pores was compared to that of seven small polar compounds of bitumen that are assumed to be potential candidates to substitute for ethylenediamine after its gradual discharge into the medium. These small polar compounds may also function as the external stimulus to facilitate detachment of amine molecules and their release into the bitumen matrix.

The seven small molecules selected here (quinoline, pyridine, benzofuran, benzoic acid, hexanal, 3-pentylthiophene, and hexanethiol (Table 1)) contain polar groups of N, O, and S that intensify their interactions with electrostatic fields inside the zeolite pores. Depending on the source of crude oil and the manufacturing processes, the chemical composition of bitumen varies. A general estimation of bitumen's elemental analysis is that most bitumens contain 79%-88% by weight of carbon, 7%-13% H, 8% S, 2%-8% O, 3% N, and trace amounts of metals such as iron, nickel, and vanadium. Many compounds of bitumen are polar compounds carrying S-, N-, and O-containing functional groups such as thiol, amine, amide, phenol, carboxyl, and alcohol. In the list of polar compounds selected for interaction with zeolite, some polar compounds such as benzoic acid, benzofuran, hexanethiol, and hexanal are volatile or semi-volatile compounds of bitumen that can be emitted from the bituminous composites, negatively impacting both air quality and the durability of composites. For many years, asphalt pavement and asphalt binder (bitumen) have been known as sources of hazardous emissions during hot applications. However, asphalt emissions are not limited to high temperatures during the production of asphalt mixtures or paving operations; there are continuous emissions at ambient temperatures, and the emissions significantly worsen when surfaces are exposed to solar radiation or high temperatures.

TABLE 1
Ethylenediamine and potential polar compound candidates of bitumen
for substitution of the ethylenediamine molecules or accommodating
the locations vacated by ethylenediamine molecules in zeolite pores.

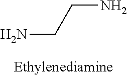

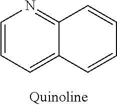

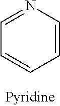

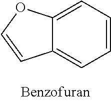

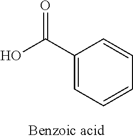

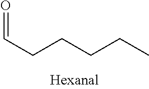

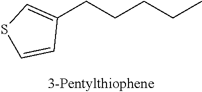

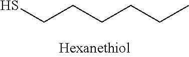

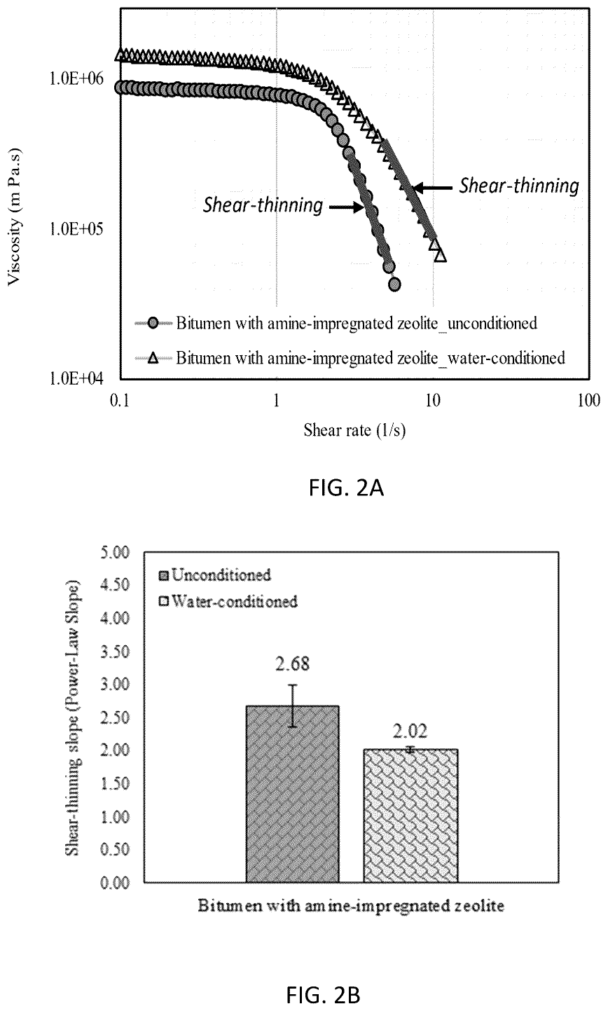

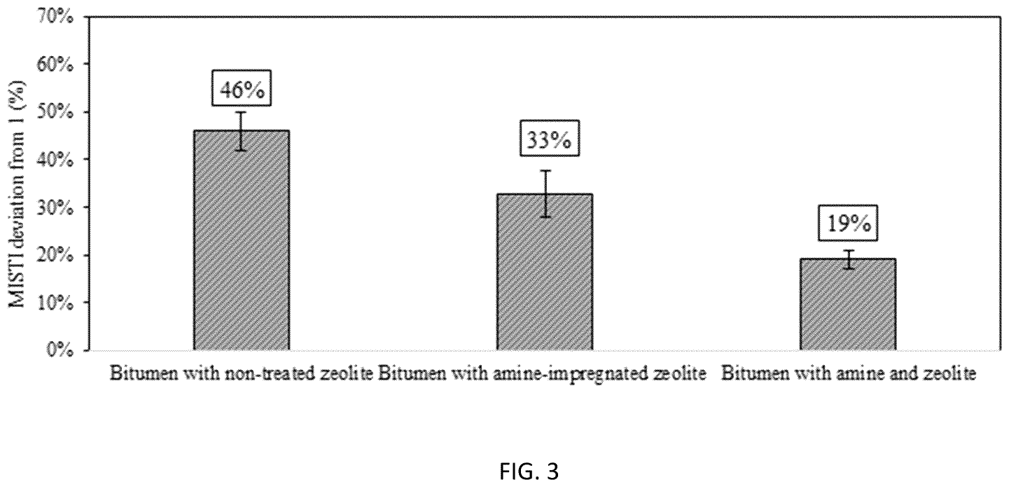

FIGS. 2A and 2B show the viscosity measured at different shear rates and the power-law slope of shear thinning, respectively, for bitumen with amine-impregnated zeolite, before and after water conditioning. After water conditioning, the viscosity increased, and the shear-thinning slope was reduced. The interaction between bitumen and glass beads is closely related to shear-thinning slope; a steeper shear-thinning slope indicates greater interaction between bitumen and glass beads. Better resistance to moisture damage is associated with a MISTI value closer to 1. A MISTI value of 1 implies no changes at the interface due to water. Improvements in moisture resistance were observed for bitumen containing amines; bitumen containing amines had MISTI deviations values lower than MISTI deviation value of bitumen containing non-treated zeolite. The presence of acidic compounds at the bitumen-silica interface leads to increased susceptibility to moisture damage. Amines can neutralize silica's active sites, preventing the accumulation of these acidic compounds at the bitumen-stone interface. FIG. 3 shows the deviation of MISTI from the value of 1 for bitumens containing zeolite. Bitumen with non-treated zeolite exhibited the worst resistance to moisture damage, with 46% deviation. Bitumen with amine-impregnated zeolite (33% deviation) showed better resistance to moisture damage than bitumen with non-treated zeolite. Bitumen with amine and zeolite (19% deviation) showed better resistance than bitumen with amine-impregnated zeolite. Hence, the MISTI deviation value for bitumen with amine-impregnated zeolite (33%) shows that only a portion of the amine molecules are released into the bitumen matrix. This is supported by the MISTI deviation value for bitumen with amine and zeolite (19%) in which all the amine molecules are available in the matrix of bitumen at the mixing time.

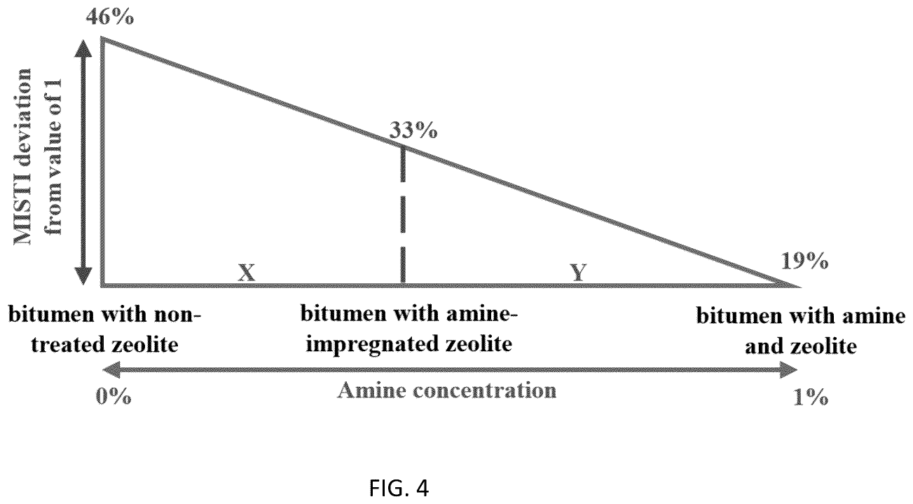

FIG. 4 refers to amine concentrations (by weight) and MISTI deviations for bitumens containing zeolite, in order to estimate the amine released from amine-impregnated zeolite into the matrix of bitumen. Considering the amine concentration in each bitumen, 0% amine corresponds to bitumen with non-treated zeolite, and 1% amine corresponds to bitumen with amine and zeolite. Hence, the amine released from amine-impregnated zeolite into bitumen can be estimated using linear interpolation (as shown in FIG. 4). It was found that 48% of absorbed amine has been released into bitumen, and 52% of the amine has not yet been released from the amine-impregnated zeolite.

Referring to FIG. 4, the amine released from amine-impregnated zeolite, by bitumen's weight, is given by 1%—Y. Linear interpolation using

$$\frac{33 \% - 19 \%}{Y} = \frac{46 \% - 19 \%}{1 \%}$$

gives Y=0.52%. The amine released from amine-impregnated zeolite, by bitumen's weight, is thus given by 1%-0.52%=0.48%, and the percentage of amine released from amine-impregnated zeolite is given by

$$\frac{0.48 \%}{1 \%} \times 100 = 48 \% .$$

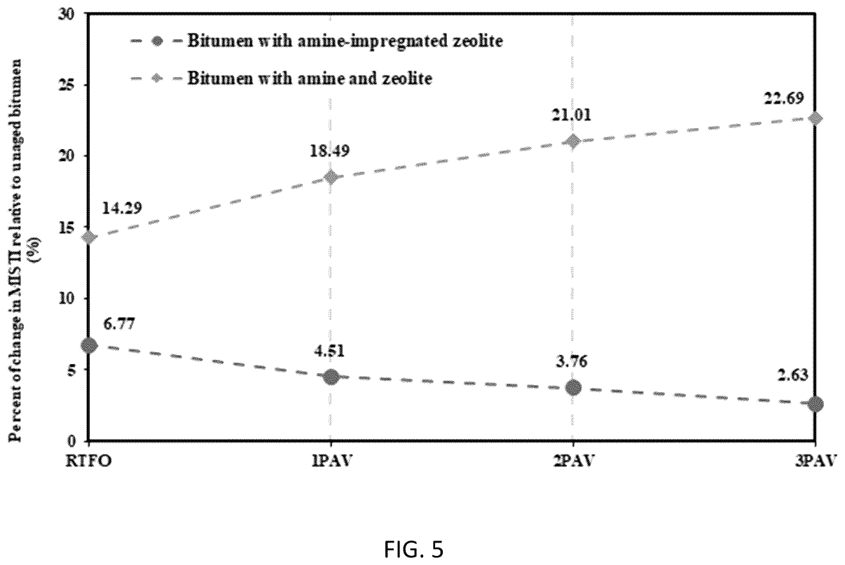

FIG. 5 shows the performance of bitumen containing amine-impregnated zeolite compared to the bitumen where amine and zeolite are added separately. Each PAV treatment consists of 20 hours of aging in a heated vessel pressurized to 2.10 MPa. As the accelerated aging progresses up to 60 hours in the 3PAV case, the difference in moisture resistance between the two bitumens increases. This increase in difference is attributed to the gradual release of amines that are retained in zeolite pores. Amine molecules added directly to bitumen age rapidly and lose their effectiveness as an anti-moisture additive; therefore, they are no longer available to protect against moisture. This, in turn, causes the MISTI (an indicator of moisture damage) to rapidly increase (14%-22%) relative to the unaged status as aging progresses. In contrast, in the case of bitumen with amine-impregnated zeolite, amines maintain their effectiveness for a long period; the MISTI remains low (2%-6%) up to 3PAV.

### DFT-Based Molecular Modeling

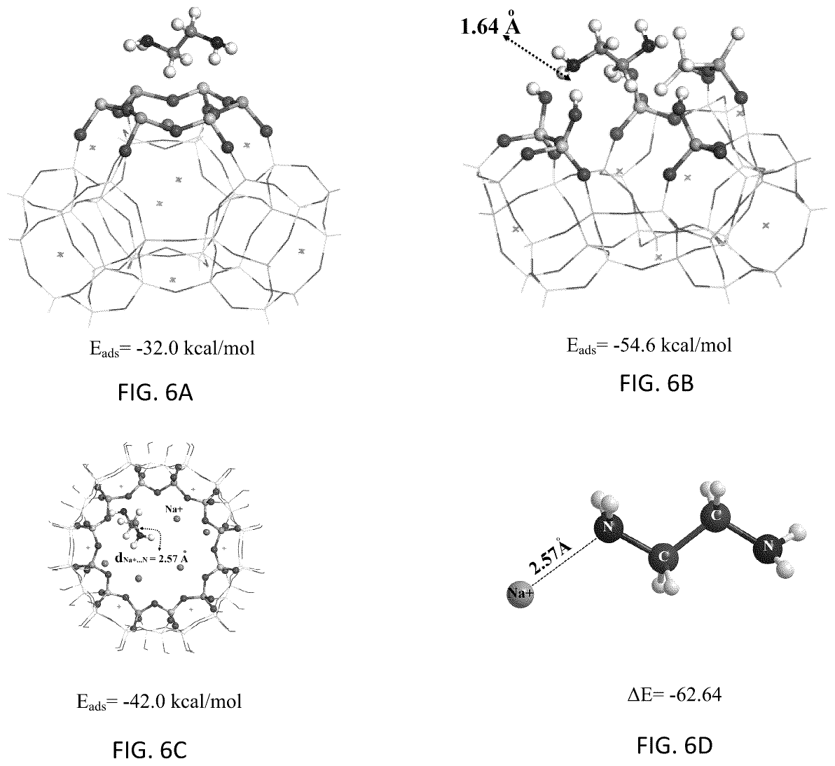

FIGS. 6A and 6B show the adsorption of ethylenediamine onto the two sodalite cages exposed to the Miller index surfaces {111} and {100}, respectively; here, these surfaces are named the {111} sodalite cage and the {100} sodalite cage. The most stable {111} sodalite cage is not broken by the Miller index surface, and the inside of the cage is not accessible to guest molecules. However, the DFT-based results show that the exterior walls of the sodalite cage, including the 6-ring sides, provide an appropriate electrostatic field for adsorption of ethylenediamine molecules. As depicted in FIG. 6A, the interaction of an ethylenediamine molecule with the 6-ring side of the {111} sodalite cage is associated with −32.0 kcal/mol adsorption energy, which can provide stability for the compound. This stabilization energy can be attributed to the electrostatic field of the sodalite framework, containing Al, Si, and O atoms of the hexagonal face, and an extra-framework Na cation that is accommodated on top of the hexagonal face of the sodalite cage.

The {100} sodalite cage is cut parallel to and just below the 4-rings face. Regardless of the probable transport of ethylenediamine into the broken cage, there are strong interactions between the active sites of the broken edge (containing OH groups) and the NH₂ groups of ethylenediamine. As shown in FIG. 6B, this adsorption is associated with H-bonding interaction between the N of amine and the OHs of the broken edge (binding distance=1.64 Å), leading to −54.6 kcal/mol stabilizing energy. The broken cage has a considerable potential to adsorb ethylenediamine compared to the unbroken cage.

FIG. 6C simulates the presence of an ethylenediamine molecule in a supercage window consisting of a 12-member ring. The stabilization energy of one ethylenediamine molecule in this 12-member ring is −42.0 kcal/mol, which is more than that from an interaction with an exterior wall of a small cage (−32.0 kcal/mol) and less than that from an interaction with a broken small cage (−54.6 kcal/mol). The extensive space of a supercage window and the large number of Na cations in this space suggests that the individual molecules of ethylenediamine receive the electrostatic forces arising from the large number of Na cations before those of the side walls originating from Si and Al tetrahedrons. These extra-framework cations counterbalance the negative charges of the zeolite's framework generated due to the charge difference between Si⁺⁴ and Al⁺³ in zeolites containing aluminum. Isolated from the zeolite medium, DFT calculations show a good interaction between ethylenediamine (as a basic amine) and Na+ that is associated with a considerable stabilization energy, −62.6 kcal/mol, as depicted in FIG. 6D. The potential of amine molecules interacting with metals is corroborated by the corrosion inhibition of metals by aliphatic amines. The anti-corrosion properties of amine compounds are closely related to the formation of amine-metal coordination bonds followed by the adsorption of amine on the surface of the target metal. The hydrophobic film created significantly reduces the access of both water and aggressive ions to the protected surface.

Despite the electrostatic attractions between ethylenediamine and Na cations in open pores, the test results show that 48% of the ethylenediamine gradually releases into the bitumen matrix. This indicates that not all the ethylenediamine molecules take advantage of cation attractions in open pores, probably because of the improper orientations of amines and cations, an insufficient number of Na cations in pore spaces, or H-bonding interactions among ethylenediamine molecules. The type and the number of cations directly affect the accessible volume for incoming guest molecules: monovalent cations occupying every cationic site present a smaller pore volume compared to divalent cations occupying every other cationic position.

Without being bound by theory, it is possible that the zeolite's locations vacated by ethylenediamine are reloaded by some small organic compounds of bitumen. Another possibility may be that some polar molecules of bitumen are able to substitute for the ethylenediamine molecules, stimulating their release into the bitumen matrix. Based on the DFT results, the adsorption strength of ethylenediamine in a supercage-window space is less than that for incomplete sodalite cages. The weak adsorption sites for ethylenediamine could be potential targets for bitumen molecules. The DFT-based energies obtained for adsorption of ethylenediamine molecules on three adsorption sites shown in FIGS. 6A-6C are compared with the energies for adsorption of seven small polar molecules of bitumen shown in Table 1. There are three target adsorption sites: the {111} sodalite cage (top of the 6-ring window of the sodalite cage); the {100} sodalite cage (broken cage); and a 12-member entrance window of a Faujasite supercage.

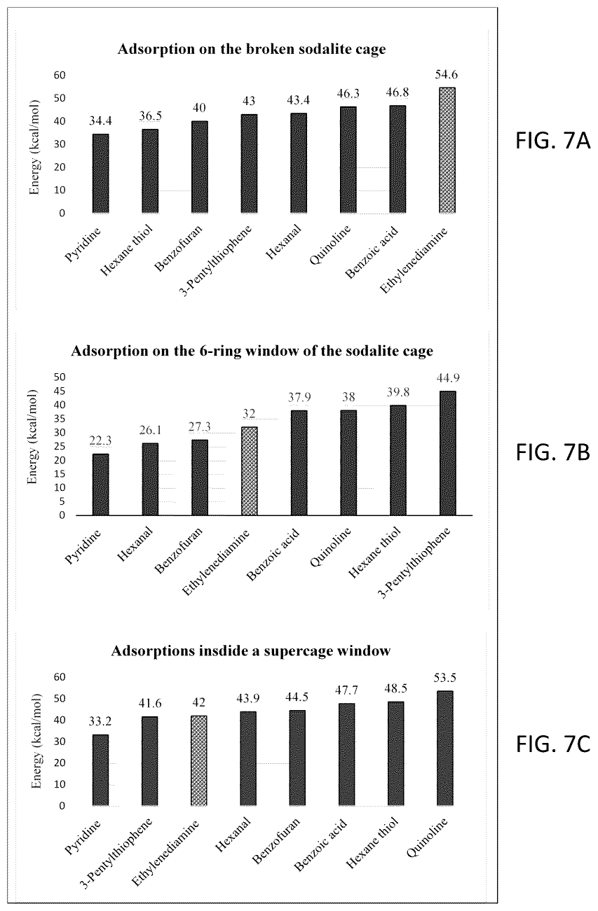

Based on the DFT results, the incomplete sodalite cage with its H-bonding interactions (H—O . . . . N) on the broken edges depicted in FIG. 6B still has the most interaction with an ethylenediamine molecule (E_{ads}=−54.6 kcal/mol) compared to the seven polar compounds of bitumen shown in FIG. 7A. This indicates that the ethylenediamine molecules grafted on this active site are not easily substituted by incoming bitumen molecules and not easily discharged to the bitumen matrix.

Compared to adsorption on the incomplete (broken) sodalite, an ethylenediamine molecule adsorbed on top of the 6-ring window of a complete sodalite cage depicted in FIG. 6A shows much less adsorption energy (E_{ads}=−32.0 kcal/mol). This indicates that the molecules adsorbed to the exterior walls of a sodalite cage are more susceptible to be removed and released into the medium. As shown in FIG. 7B, several polar organic compounds of bitumen (including benzoic acid, quinoline, hexanethiol, and 3-pentylthiophene) have greater adsorption energies compared to ethylenediamine and consequently could be potential candidates for substituting the locations of ethylenediamine

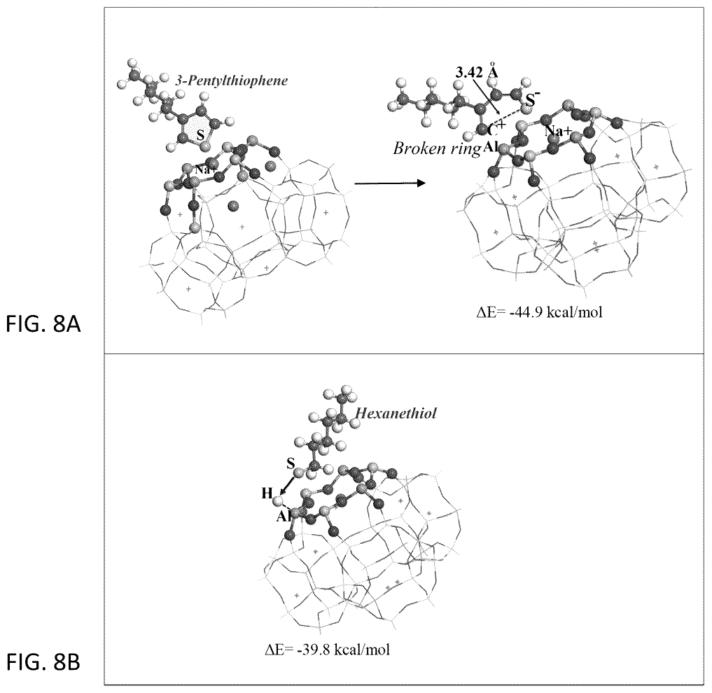

The DFT-based calculations show the breaking of covalent bonds and forming of new bonds in organic compounds of bitumen in interaction with the exterior walls of a sodalite cage, leading to the higher interaction energies for these typical molecules. Among the molecules involved in these chemical reactions are some S-containing compounds such as 3-pentylthiophene and hexanethiol depicted in FIGS. 8A and 8B. 3-pentylthiophene undergoes the opening of a thiophene ring followed by the C—S bond cleavage depicted in FIG. 8A, and hexanethiol undergoes an intermolecular H-transfer reaction followed by the S—H bond cleavage depicted in FIG. 8B.

Interactions inside the supercage window are mainly related to the Na cations in this space. Adsorption of one ethylenediamine molecule in this space is associated with −42.0 kcal/mol stabilization energy, which is less than that in a broken cage depicted in FIG. 6C. Referring to FIG. 7C, the trend of energy for the other seven polar organic compounds in this space shows that at least five of them (benzoic acid, quinoline, hexanethiol, benzofuran, and hexanal) could replace the ethylenediamine molecule in this space because their adsorption strength is more than (or comparable with) that for an ethylenediamine molecule.

The results described here are based on one individual ethylenediamine molecule in this extensive space (a 12-ring entrance window of a cavity). In a real system, the large number of ethylenediamine molecules and the H-bonding interactions between each pair of ethylenediamine molecules boost their tendency to remain in this space (12-ring entrance window of a cavity). However, based on the MISTI results that indicate the release of 48% of the ethylenediamine molecules, the extensive spaces of cavities and their entrance windows with a limited number of Na cations are the most probable locations for releasing some of the ethylenediamine molecules.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

1-23. (canceled)

24. An asphalt composition comprising:
aggregate; and
a bitumen composite comprising:
an amine-impregnated zeolite comprising a zeolite impregnated with a polar compound; and
bitumen.

25. The asphalt composition of claim 24, wherein the bitumen composite comprises about 0.1 wt % to about 5 wt % of the polar compound.

26. The asphalt composition of claim 24, wherein a weight ratio of the polar compound to the zeolite is up to about 1.

27. The asphalt composition of claim 26, wherein the weight ratio is in a range of about 0.6 to 1.

28. The asphalt composition of claim 24, wherein the bitumen composite comprises up to 5 wt % of the zeolite.

29. The asphalt composition of claim 24, wherein the polar compound comprises ethylenediamine.

30. The asphalt composition of claim 24, wherein the polar compound comprises quinoline.

31. The asphalt composition of claim 24, wherein the polar compound comprises pyridine.

32. The asphalt composition of claim 24, wherein the polar compound comprises benzofuran.

33. The asphalt composition of claim 24, wherein the polar compound comprises benzoic acid.

34. The asphalt composition of claim 24, wherein the polar compound comprises hexanal.

35. The asphalt composition of claim 24, wherein the polar compound comprises 3-pentylthiophene.

36. The asphalt composition of claim 24, wherein the polar compound comprises hexanethiol.

37. The asphalt composition of claim 24, wherein the zeolite comprises a natural or synthetic zeolite.

38. The asphalt composition of claim 37, wherein the zeolite comprises a Faujasite-type zeolite.

39. The asphalt composition of claim 24, wherein the aggregate comprises one or more of sand, crushed stone, gravel, and rock dust.
